(19) United States
(12) Patent Application Publication
(10) Pub. No.: US 2008/0316155 A1
(43) Pub. Date: Dec. 25, 2008

(54) COMPUTER AND DISPLAY CONTROL METHOD FOR THE SAME

(75) Inventor: Yuichiro Hino, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/141,643

(22) Filed: Jun. 18, 2008

(30) Foreign Application Priority Data
Jun. 20, 2007 (JP) 2007-162895

(51) Int. Cl. G09G 3/36

(52) U.S. Cl. 345/87

(57) ABSTRACT

According to one embodiment, there is provided a computer including a display to display a video in one of a normal mode in which the video is displayed according to a progressive scheme and a multi-field drive mode in which the video is displayed according to an interlace scheme, and a control device to supply specification information specifying one of the normal mode and the multi-field drive mode, to the display.

### CROSS-REFERENCE TO RELATED APPLICATIONS

This application is based upon and claims the benefit of priority from Japanese Patent Application No. 2007-162895, filed Jun. 20, 2007, the entire contents of which are incorporated herein by reference.

### BACKGROUND

1. Field

One embodiment of the invention relates to a computer including a display and a display control method for the computer.

2. Description of the Related Art

Various techniques have been proposed which control power saving for information apparatuses such as personal computers. For example, Jpn. Pat. Appln. KOKAI Publication No. 9-90317 shows an example of a technique of controlling power saving for a personal computer. In an example described in this document, a back light of a liquid crystal display in the personal computer is appropriately turned off or the luminance of the back light is reduced, in order to reduce the power consumption of the liquid crystal display.

There has been a demand for a reduction in power consumed by the personal computer below that consumed according to the conventional techniques. However, only a limited reduction in the power consumption of the personal computer can be achieved simply by appropriately turning off the back light or reducing the luminance of the back light as is the case with the conventional techniques.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of a personal computer as an embodiment of an information processing apparatus according to the invention;

FIG. 2 is an exemplary block diagram showing the system configuration of the personal computer shown in FIG. 1; and

FIG. 3 is an exemplary block diagram showing a part of the personal computer shown in FIG. 2, in detail.

### DETAILED DESCRIPTION

Various embodiments according to the invention will be described hereinafter with reference to the accompanying drawings. In general, according to one embodiment of the invention, there is provided a computer comprising a display to display a video in one of a normal mode in which the video is displayed according to a progressive scheme and a multi-field drive mode in which the video is displayed according to an interlace scheme, and a control device to supply specification information specifying one of the normal mode and the multi-field drive mode, to the display.

In the description, the same components or components having the same functions are denoted by the same reference numerals, and duplicate descriptions are omitted.

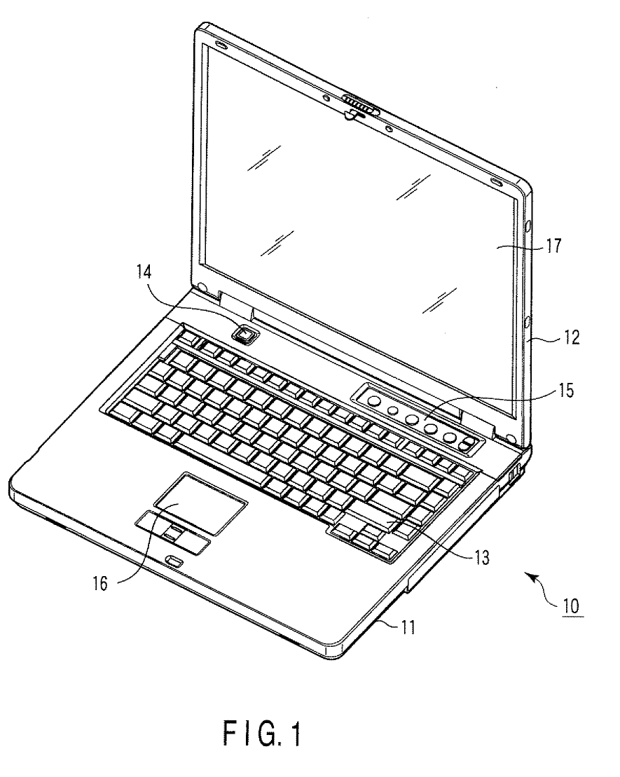

As shown in FIG. 1, a notebook personal computer (information processing apparatus) 10 includes a computer main body 11 and a display unit 12. A display device including a liquid crystal display (LCD) 17 is incorporated in the display unit 12. A display screen of LCD 17 is positioned substantially in the center of the display unit 12.

The display unit 12 is mounted so as to be pivotable between an open position and a closed position with respect to the computer main body 11. The computer main body 11 has a thin box-like housing and includes a keyboard 13, a power button 14, an input operation panel 15, and a touch pad 16 arranged on a top surface; the power button 14 is used to power on and off the personal computer 10.

Now, the system configuration of the personal computer 10 will be described.

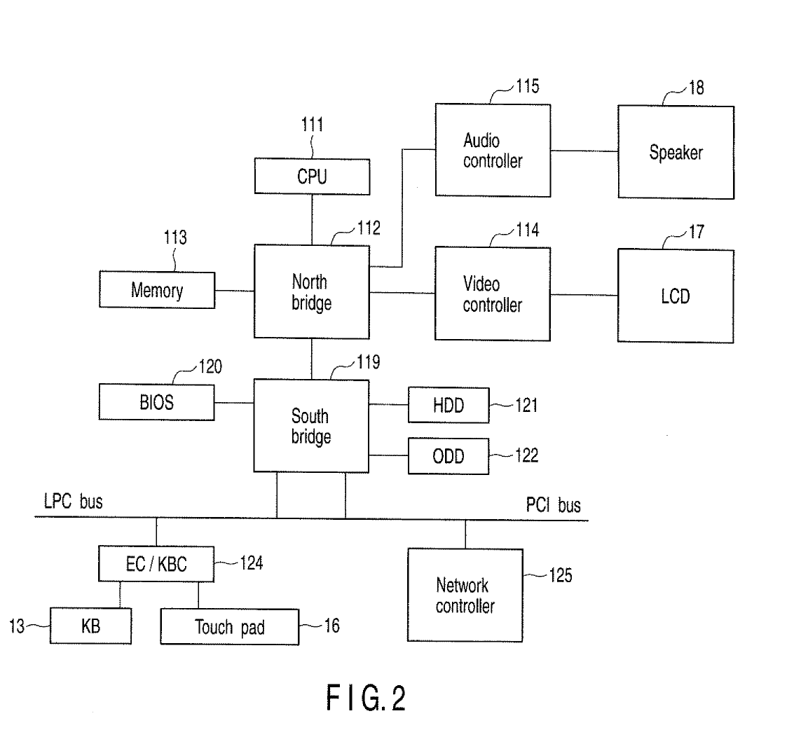

As shown in FIG. 2, the personal computer 10 includes CPU 111, a north bridge 112, a main memory 113, a video controller 114, an audio controller 115, a south bridge 119, a basic input/output system (BIOS) 120, a hard disk drive (HDD) 121, an optical disk drive (ODD) 122, an embedded controller/keyboard controller IC (EC/KBC) 124, and a network controller 125.

CPU 111 is a processor that controls the operation of the personal computer 10. CPU 111 executes an operating system (OS) that is loaded from HDD 121 into the main memory 113 as well as various application programs. CPU 111 also executes a system BIOS stored in BIOS 120 that is a nonvolatile memory. The system BIOS is a program that controls hardware.

The north bridge 112 is a bridge device that connects a local bus from CPU 111 to the south bridge 119. The north bridge 112 also has a built-in memory controller that controls accesses to the main memory 113. The north bridge 112 also has a function of communicating with the video controller 114 via an accelerated graphics port (AGP) bus or the like and with the audio controller 115.

The video controller 114 is a video reproduction controller that controls LCD 17 used as a display monitor for the personal computer 10. The video controller 114 generates reproduction signals to be delivered from decoded video images to LCD 17.

The audio controller 115 is an audio reproduction controller that controls a speaker 18 for the personal computer 10. The audio controller 115 generates reproduction signals to be delivered from decoded audio data to the speaker 18.

The south bridge 119 controls appropriate buses on an low pin count (LPC) bus and appropriate devices on a peripheral component interconnect (PCI) bus. The south bridge 119 has a built-in integrated drive electronics (IDE) controller that controls HDO 121 and ODD 122. The south bridge 119 further has a function of controlling accesses to BIOS 120.

HDD 121 is a storage device that stores various types of software and data. ODD 122 is a drive unit that drives storage media such as DVD in which video contents are stored.

EC/KBC 124 is a one-chip microcomputer in which an embedded controller and a keyboard controller are integrated together; the one-chip microcomputer manages power, and the keyboard controller controls the keyboard (KB) 13 and the touch pad 16. EC/KBC 124 has a function of turning on and off a power supply for the personal computer 10 in response to an operation of a power button 14 by a user. The network controller 125 is a communication device that communicates with an external network, for example, the Internet.

LCD 17 according to the present embodiment is a semi-transmissive liquid crystal display having both a function of making display contents visible utilizing reflected light and a function of making the display contents visible utilizing a back light. However, LCD 17 may be a reflective liquid crystal display that makes the display contents visible utilizing only reflected light or a transmissive liquid crystal display that makes the display contents visible utilizing only the back light.

LCD 17 displays videos in either a normal mode in which the videos are displayed according to a progressive scheme or a multi-field drive mode in which the videos are displayed according to an interlace scheme. The user can selects one of the normal mode and the multi-field drive mode. LCD 17 executes a multi-field drive (MFD) function in order to display the videos in the multi-field drive mode. The multi-field drive function is an LCD driving technique of adaptively varying a video redraw frequency depending on the amount of motion in the video displayed on LCD 17 to reduce power consumption. With the multi-field drive function, if the video redraw frequency decreases below a predetermined threshold, the videos are displayed according to the interlace scheme to inhibit possible flickers on the screen. The multi-field drive function is described in Jpn. Pat. Appln. KOKAI Publication No. 2004-46180 (application number: 2003-188648) and the like in detail.

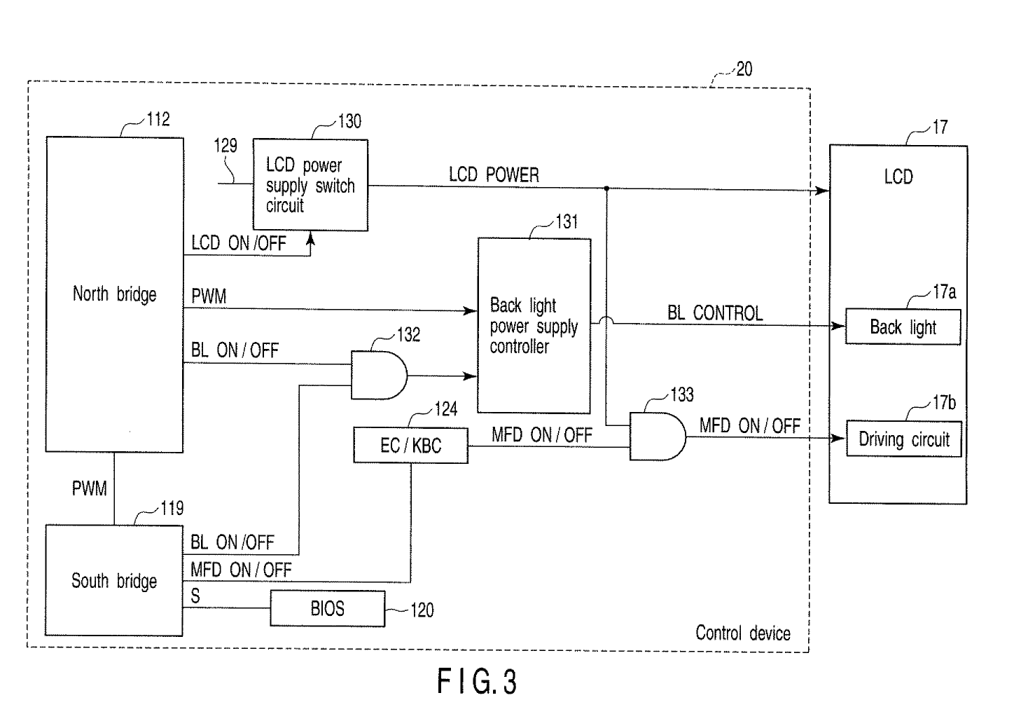

Now, description will be given of arrangements in the personal computer 10 which relates to the control of LCD 17. FIG. 3 is a diagram showing the configuration of a part of the personal computer shown in FIG. 2, in detail. FIG. 3 shows LCD 17 and a control device 20.

LCD 17 includes a back light 17a and a driving circuit 17b. The control device 20 includes a group of devices relating to the control of LCD 17.

BIOS 120 outputs a control signal S containing luminance setting information, back light setting information, MFD function setting information, and the like, to the south bridge 119. Here, the luminance setting information is set by the user to adjust the luminance of the back light. In the present embodiment, the luminance of the back light can be adjusted among eight levels. The user selectively sets one of the eight levels of the luminance. The back light setting information is set by the user to turn on or off the back light 17a. The MFD function setting information is set by the user to enable or disable the MFD function. These pieces of setting information are set by the user via a BIOS setting screen during the operation of the personal computer 10.

The south bridge 119 transfers the setting information from BIOS 120 to other devices. That is, the south bridge 119 transfers the luminance setting information PWM from BIOS 120 to the north bridge 112. The south bridge 119 transfers the back light setting information BL_ON/OFF from BIOS 120 to a first AND circuit 132. The south bridge 119 further transfers the MFD setting information MFD_ON/OFF from BIOS 120 to EC/KBC 124.

The north bridge 112 outputs control signals that control LOD 17 to other devices. That is, the north bridge 112 outputs an LCD power supply control signal LCD_ON/OFF to an LCD power supply switch circuit 130. The north bridge 112 further transfers the luminance setting information PWM from the south bridge 119 to a back light power supply controller 131. The north bridge 112 further outputs a backlight control signal BL_ON/OFF to the first AND circuit 132. The back light control signal BL_ON/OFF changes from an on signal to an off signal when, for example, the display unit 12 changes from the open position to the closed position with respect to the computer main body 11. 10

The LCD power supply switch circuit 130 switches the connection condition between a power supply line 129 and LCD 17. On the basis of an LCD power supply control signal LCD_ON/OFF from the north bridge 112, the LCD power supply switch circuit 130 determines whether to set the connection condition between the power supply line 129 and LCD 17 to a conductive state or a disconnected state. When the LCD power supply switch circuit 130 sets the connection condition between the power supply line 129 and LCD 17 to the conductive state, power LCD_POWER is supplied to LCD 17 through the power supply line 129. On the other hand, when the LCD power supply switch circuit 130 sets the connection condition between the power supply line 129 and LCD 17 to the disconnected state, the power LCD_POWER is not supplied to LCD 17 through the power supply line 129. Furthermore, upon setting the power supply line 129 and LCD 17 to a connected state, the LCD power supply switch circuit 130 outputs an on signal to a second AND circuit 133. Upon setting the power supply line 129 and LCD 17 to a disconnected state, the LCD power supply switch circuit 130 outputs an off signal to the second AND circuit 133.

The first AND circuit 132 loads the back light control signal BL_ON/OFF from the north bridge 112 and the back light setting information BL_ON/OFF from the south bridge 119. On the basis of these signals, the first AND circuit 132 generates and outputs a new back light control signal to the back light power supply controller 131. More specifically, if these signals are both on signals specifying turn-on of the back light 17a, the first AND circuit 132 outputs an on signal to the back light power supply controller 131. On the other hand, if at leas one of the signals is an off signal specifying turn-off of the back light 17a, the first AND circuit 132 outputs an off signal to the back light power supply controller 131.

The back light power supply controller 131 loads the back light control signal from the first AND circuit 132 and the luminance setting information PWM from the north bridge 112. On the basis of these signals, the back light power supply controller 131 generates and outputs a back light control signal BL_CONTROL that controls the back light 17a, to the back light 17a. More specifically, if the back light control signal from the first AND circuit 132 is the on signal, the back light controller 131 generates and outputs a back light control BL_CONTROL that allows the back light 17a to be turned on in response to the luminance setting information PWM from the north bridge 112. On the other hand, if the back light control signal from the first AND circuit 132 is the off signal, the back light power supply controller 131 generates and outputs a back light control signal BL_CONTROL that allows the back light 17a to be turned off.

EC/KBC 124 transfers the MFD setting information MFD_ON/OFF from the south bridge 119 to a second AND circuit 133.

The second AND circuit 133 loads the on and off signals from the LCD power supply switch circuit 130 and the MFD setting information MFD_ON/OFF from EC/KBC 124. The second AND circuit 133 generates and outputs an MFD control signal MED_ON/OFF based on these signals, to the driving circuit 17b. The MFD control signal MFD_ON/OFF is specification information specifying one of the normal mode and the MFD mode. More specifically, if signals from the LCD power supply switch circuit 130 and EC/KBC 124 are both on signals, the second AND circuit 133 generates and outputs an on signal to specify the MFD mode. On the other hand, at least one of the signals from the LCD power supply switch circuit 130 and EC/KBC 124 is an off signal, the second AND circuit 133 generates and outputs an off signal to specify the normal mode.

The driving circuit 17b, built in LCD 17, loads the MFD control signal MFD_ON/OFF from the second AND circuit 133. If the MFD control signal MFD_ON/OFF is an on signal, the driving circuit 17b enables the MFD function. At this time, the driving circuit 17b adaptively varies the video redraw frequency depending on the amount of motion in the video displayed on LCD 17. The driving circuit 17b further displays the videos according to the interlace scheme in association with a decrease in view redraw frequency. On the other hand, if the MFD control signal MED_ON/OFF is an off signal, the driving circuit 17b disables the MFD function. At this time, the driving circuit 17b is set to the normal mode to fix the video redraw frequency while displaying the videos on LCD 17 according to the progressive scheme.

In the present embodiment, the MFD function is applied to LCD 17 of the personal computer 10. Thus, the videos are displayed on LCD 17 according to the interlace scheme, enabling a reduction in the power consumption of the personal computer 10. Thus, the user can use the personal computer 10 for a long time without the need to feed external power to the personal computer 10.

(First Variation)

Now, a first variation of the personal computer 10 will be described.

The personal computer 10 according to the first variation enables the MFD function of the driving circuit 17b if the luminance of the back light 17a is lower than a preset threshold (for example, a value of about 10 to 30 candela). The personal computer 10 according to the first variation disables the MFD function of the driving circuit 17b if the luminance of the back light 17a is higher than the preset threshold. When the back light 17a offers a low luminance, a change in video quality is not recognized by the user even with the enabled MFD function. Thus, by enabling the NFD function with the back light 17a offering a low luminance, it is possible to reduce the power consumption of the personal computer 10 while preventing a change in video quality from being recognized by the user.

The method of enabling the MFD function if the luminance of the back light is lower than the predetermined threshold may be performed as follows. For example, when the luminance setting information PWM set in BIOS 120 indicates the lowest or second lowest one of the eight levels, the MFD control information MFD_ON/OFF, output by BIOS 120, is set for an on signal to enable the MED function. On the other hand, when the luminance setting information PWM set for BIOS 120 indicates one of the third lowest to highest levels, the MFD control information MFD_ON/OFF, output by BIOS 120, is set for an off signal to enable the MFD function.

Alternatively, the back light power supply controller 131 may output the back light control signal BL_CONTROL to the driving circuit 17b, which may then determine, on the basis of the back light control signal BL_CONTROL, whether or not the luminance of the back light 17a is lower than a predetermined threshold, to determine whether to enable or disable the MFD function.

(Second Variation)

A second variation of the personal computer 10 will be described below.

The personal computer 10 according to the second variation enables the MED function of the driving circuit 17b in order to turn off the back light 17a and disables the MED function of the driving circuit 17b in order to turn on the back light 17a. When the back light 17a is off, a change in video quality is not recognized by the user even with the enabled MFD function. Enabling the MFD function with the back light 17a remaining off enables a reduction in the power consumption of the personal computer 10 while preventing the user from recognizing a change in video quality.

The method of enabling the MFD function if the back light 17a is turned off may be performed as follows. For example, when the back light setting information BL_ON/OFF set in BIOS 120 indicates that the back light is to be turned off, the MFD control information MFD_ON/OFF, output by BIOS 120, is set for an on signal to enable the MFD function. On the other hand, when the back light setting information BL_ON/OFF set in BIOS 120 indicates that the back light is to be turned on, the MFD control information MED_ON/OFF, output by BIOS 120, is set for an off signal to enable the MFD function.

Alternatively, the back light power supply controller 131 may output the back light control signal BL_CONTROL to the driving circuit 17b, which may then determine, on the basis of the back light control signal BL_CONTROL, whether or not the back light 17a is off, to determine whether to enable or disable the MFD function.

As described above in detail, the above-described technique can provide a personal computer and a display control method for the personal computer which enable a reduction in the power consumption of a display.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A computer comprising:
a display to display a video in one of a normal mode in which the video is displayed according to a progressive scheme and a multi-field drive mode in which the video is displayed according to an interlace scheme; and
a control device to supply specification information specifying one of the normal mode and the multi-field drive mode, to the display.

2. The computer according to claim 1, wherein the multi-field drive mode is a mode in which a video redraw frequency is varied depending on amount of motion in the video and in which the video is displayed according to the interlace scheme.

3. The computer according to claim 1, wherein the specification information is information based on specification of one of the normal mode and the multi-field drive mode by a user.

4. The computer according to claim 1, wherein the specification information is information which allows the normal mode to be selected when luminance of the display is greater than a predetermined threshold and which allows the multi-field drive mode to be selected when the luminance of the display is lower than the predetermined threshold.

5. The computer according to claim 1, wherein the specification information is information which allows the normal mode to be selected when a back light of the display is to be turned on and which allows the multi-field drive mode to be selected when the back light of the display is to be turned off.

6. The computer according to claim 1, wherein the display is a semi-transmissive liquid crystal display or a reflective liquid crystal display.

7. The computer according to claim 1, wherein the control device includes a device in which specification information indicating one of the normal mode and the multi-field drive mode specified by the user is registered.

8. The computer according to claim 1, wherein the control device includes a device which supplies the specification information specifying the multi-field drive mode to the display when the display is supplied with power and when the registered specification information specifies the multi-field drive mode.

9. A display control method for a computer comprising:
supplying a display with specification information specifying one of a normal mode in which a video is displayed according to a progressive scheme and a multi-field drive mode in which the video is displayed according to an interlace scheme; and
performing display control on the display in one of the normal mode and the multi-field drive mode specified in the specification information.
